(19) United States
(12) Patent Application Publication
(10) Pub. No.: US 2011/0194241 A1
(43) Pub. Date: Aug. 11, 2011

(54) NOTEBOOK COMPUTER WITH DETACHABLE LIQUID CRYSTAL DISPLAY PANEL

(76) Inventor: Eng Sime Looi, Singapore (SG)

(21) Appl. No.: 12/810,580

(22) PCT Filed: Oct. 24, 2008
(86) PCT No.: PCT/SG2008/000411

§ 371 Date: Oct. 8, 2010

(51) Int. Cl. G06F 1/16

(52) U.S. Cl. 361/679.29

(57) ABSTRACT

A notebook computer comprising a clamshell-type housing (1), a base portion (2) and a lid portion (3) connected together for relative pivotal movement; a motherboard, computer electronics component and power supply housed within the base portion (2); an LCD panel (7) detachably mounted on the lid portion (3) and having a connector for connection to the port of the CPU of the notebook computer; a keyboard (4) detachably connectable to the CPU of the notebook computer via a USB port; and a cursor control device mounted on the housing. An interface card (12) with built-in electronics controller for connecting the detached LCD panel (7) to the desktop personal computer (10); a power adaptor (9) for supplying power to the LCD panel (7) when in free standing position and connecting to the desktop personal computer (10).

This invention relates to computers and more particularly to portable computers of the laptop or notebook type.

### BACKGROUND TO THE INVENTION

Notebook computers have the advantage of being small sized, lightweight and readily portable, which makes them particularly suitable for use by people who travel a lot. The portability of notebook computers allows users to access applications and carry out computing work at any place and any time without being desk bound.

The liquid crystal display (LCD) panel of a notebook computer is, of necessity, limited in size and is usually one of the most expensive component of any notebook computer. When the time comes to up-date a notebook computer because it no longer meets the users requirements or when the notebook computer has to be scrapped because one or more components has failed and it is uneconomic to repair, most of the still functioning components, and especially the LCD panel, are still useable, so it is uneconomic to discard the whole notebook computer including the expensive LCD, if an alternative solution were available.

### SUMMARY OF THE INVENTION

This invention provides a solution to the above problem by making the LCD panel detachable from the central processing unit (CPU) of a notebook computer and utilising a dedicated port such as USB on the CPU motherboard of the desktop personal computer (PC) for connection to the LCD panel.

Alternatively when comes to upgrading the notebook computer, the LCD panel need not to be sacrificed and can be re-connected to another notebook computer of similar manufacture.

In addition to the LCD panel being detachable from the CPU, the keyboard is also preferably detachable and connectable to the CPU of desktop personal computer (PC) by a USB port. A detachable keyboard have the advantage of preventing water or liquid spillage accidentally seep through the tiny gaps which can potentially damage the electronics components inside the CPU housing.

Thus, a notebook computer according to the invention comprises a conventional notebook computer clam shell type housing enclosing the CPU, an LCD panel detachably mounted on the lid of the housing and connectable to the CPU, the CPU having a dedicated port for connection of the LCD panel, a power source and, optionally, a detachable keyboard also connectable to the CPU via USB port. In addition the LCD panel were also provided externally an interface card with built-in electronic controller for connection to desktop PC.

The housing for the CPU will contain the motherboard, the chip sets, storage memory hard disc, power supply devices and other standard notebook computer components. The housing will also normally carry the conventional touch pad for navigation about the screen and a port for a mouse.

The LCD panel may be mounted to the lid of the housing a simple latching device but is preferably retained between a pair of spaced channel members or supported in a channel member and held in position by one or more clips. If the keyboard is also detachable the housing will also normally have storage space for the keyboard The keyboard which is detachable shall sat on top of the CPU housing.

The notebook computer of the invention has several advantages over the conventional devices in addition to the fact that a valuable LCD screen need not be thrown away with a defunct or out-of-date model. Thus, the limitations of screen size do not apply since the user can plug in a monitor with any screen size even though he may need to use an interface device in some cases to convert digital data into readable output. Likewise, the detached LCD screen can be connected with a desktop PC either alone or as a second monitor to allow multi-tasking operations. Currently conventional notebook LCD screen cannot directly connect to desktop personal computer. The LCD screen will be provided with an interface card when making connection to desktop PC. The interface card is consist of a specially designed electronic controllers whose main function is to take the digital data from desktop personal computer and converts it into proper format and timing output suitable to be displayed on the LCD screen. In addition, a connector port in the LCD panel were also provided for connection to the power adaptor when the LCD panel is connected to the desktop PC.

### DESCRIPTION OF PREFERRED EMBODIMENTS

The invention will now be described in greater detail, by way of example, with reference to the drawings, in which:

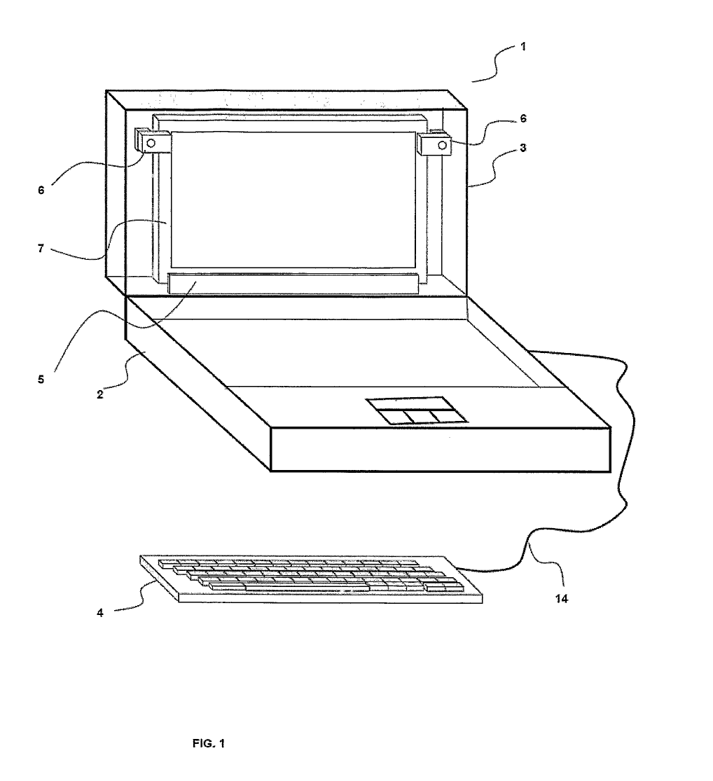

FIG. 1 is a schematic view of one form of notebook computer according to the invention;

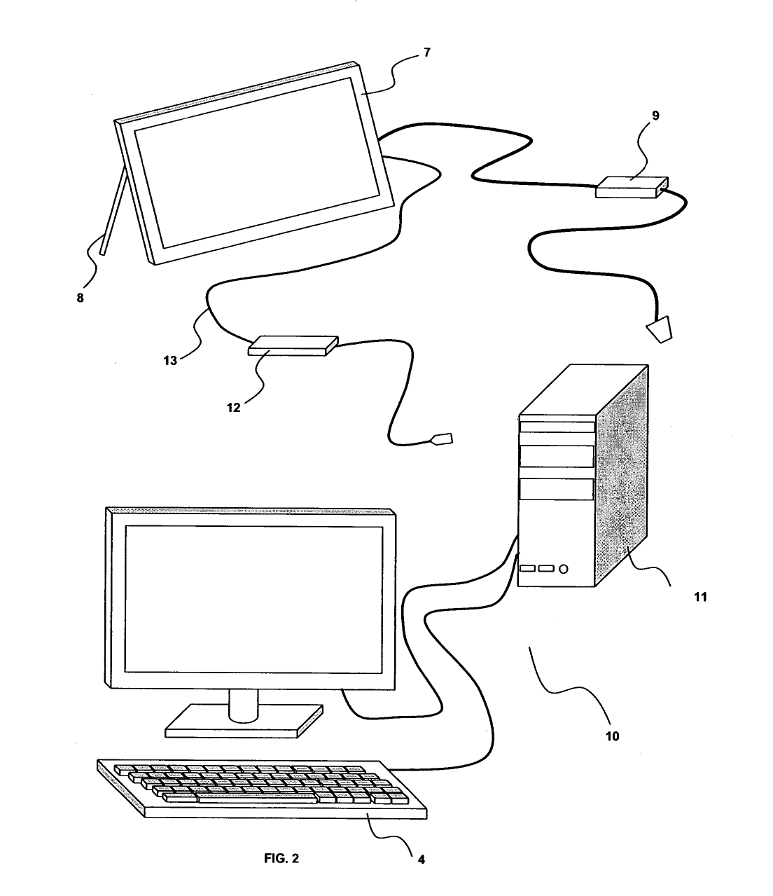

FIG. 2 is a schematic view showing the LCD panel separated from the notebook computer ready for attachment to a desktop PC;

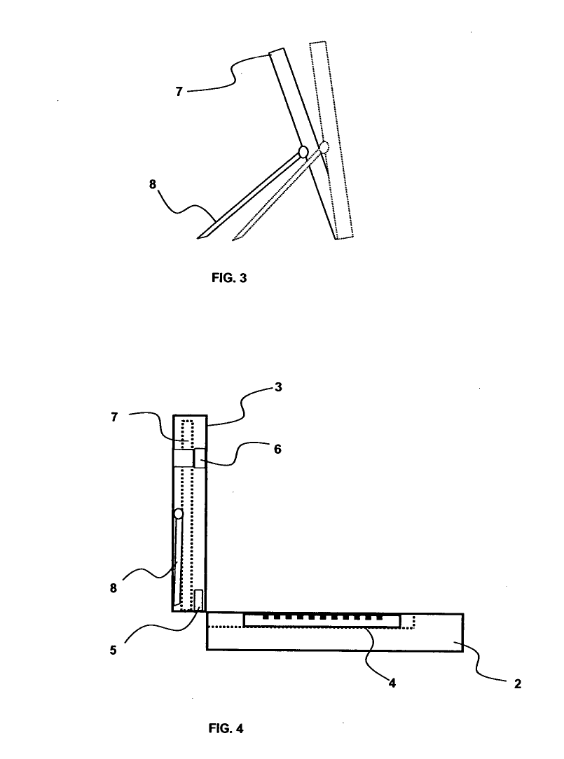

FIG. 3 is a schematic side view of the free standing LCD panel of the notebook computer shown in FIG. 1;

FIG. 4 is a schematic side view of the notebook computer shown in FIG. 1;

As shown in FIG. 1 in one form of the invention the notebook computer comprises a rectangular clamshell casing 1 consisting of a base portion 2 and a lid portion 3 joined by a hinge. Base portion 2 encloses the electronic components, such as the motherboard of the computer and any other components that may conveniently or suitable to be enclosed therein. The detachable keyboard 4 with USB connection can be sat on top of the CPU enclosed housing of base portion 2. Lid portion 3 has an upstanding flange or rib 5, which together with two clips 6 forms a retainer means for supporting the LCD panel 7.

As shown in FIGS. 2 and 3, LCD panel 7 has a pair of pivotally mounted legs 8 that support panel 7 when it is removed from the housing and used as a free-standing monitor.

FIG. 2 shows how the free-standing LCD panel 7 and, optionally, keyboard 4 can be used with a desktop PC 10. LCD panel 7 has a power adaptor 9 and a lead cable 13 with a USB connector for connecting LCD panel 7 to the CPU 11 of the PC via an interface card 12 that functions to convert digital data from CPU 11 into readable output that can be displayed on LCD panel 7. Keyboard 4 also has a lead cable 14 with a USB connector for connection to CPU 11, if necessary.

While the invention has been described with reference to an illustrative embodiment, the description is not intended to be constructed in limiting sense. Various modifications of the illustrative embodiment, as well as other embodiments of the invention will be apparent to those persons skilled in the art upon reference to this description.

1. A notebook computer comprising a clamshell-type housing (1) comprising a base portion (2) and a lid portion (3) connected together for relative pivotal movement;
a power supply housed within the base portion (2);
an LCD panel (7) detachably mounted on the lid portion (3) and having a connector for connection to a port of the CPU of the notebook computer;
a keyboard (4) detachably connectable to the CPU of the notebook computer via a USB port; and a cursor control device mounted on the housing.

2. A notebook computer according to claim 1, wherein the base portion (2) of the housing (1) houses a hard disk and a motherboard, with the CPU being mounted on the motherboard.

3. A notebook computer according to claim 1 or claim 2, wherein the base portion (2) of housing (1) also houses a chip set for connecting between the CPU and any peripheral devices connected to the computer.

4. A notebook computer according to any one of claims 1 to 3, wherein a hardisk memory is also housed in housing (1) for storing data and programs.

5. A notebook computer according to any one of claims 1 to 4, wherein the LCD panel (7) has external connections for a power adaptor (9) to power the LCD panel from an external power source, when the LCD panel (7) is connected to the desktop personal computer (11).

6. A notebook computer according to any one of claims 1 to 5, wherein the connection between the desktop personal computer (10) and the LCD panel (7) is made via interface card (12).
